(19) United States
(12) Patent Application Publication
(10) Pub. No.: US 2003/0005078 A1
(43) Pub. Date: Jan. 2, 2003

(54) Apparatus and method for providing user-requested content through an alternate network service

(76) Inventors: Thomas Edwin Turicchi JR., Dallas, TX (US); Shinobu Togasaki, San Jose, CA (US); Steven R. Landherr, Baton Rouge, LA (US)

Correspondence Address: HEWLETT-PACKARD COMPANY, Intellectual Property Administration, P.O. Box 272400, Fort Collins, CO, 80527-2400, US

(21) Appl. No.: 09/896,794

(22) Filed: Jun. 28, 2001

(51) Int. Cl. G06F 15/16

(52) U.S. Cl. 709/217; 709/239

(57) ABSTRACT

An apparatus and method for providing user-requested content through an alternate network service when the preferred network service is unavailable. The apparatus is preferably embodied in computer readable program code. The invention may comprise assessing the availability of the user-requested content from the preferred network service; selecting an alternate network service providing substantially similar content to the user-requested content when the user-requested content is unavailable from the preferred network service; and linking to the alternate network service when the user-requested content is unavailable from the preferred network service. In addition, the invention preferably comprises assessing the availability of the substantially similar content from the alternate network service.

### FIELD OF THE INVENTION

The invention generally pertains to providing user-requested content over a network, and more specifically, to providing user-requested content through an alternate network service when a preferred network service is unavailable to provide it.

### BACKGROUND OF THE INVENTION

Networks, including the Internet, are widely used by many users for a variety of purposes. For example, network services on the Internet may be accessed throughout the world for information retrieval, e-commerce, etc. In addition, the Internet has a virtually unlimited number of users accessing various network services thereon at any given time. Indeed, these network services are typically available year-round, twenty-four hours each day for seven days each week.

The resources (i.e., hardware and software) used to provide these services over the network, however, have a finite capacity that is determined by the resources allocated to the network service. That is, a particular network service (e.g., an Internet site) can only handle a finite number of requests for access thereto. However, network services frequently experience a surge in demand that approaches or exceeds the finite capacity of the resources allocated to the network service. When the demand approaches or exceeds the capacity of the resources allocated to the network service, the users may experience severely degraded performance of the network service. For example, a network service may be equipped to accommodate at most fifty users at any given time. Thus, when more than fifty users are accessing the network service, the performance of the network service declines for each user accessing the network service.

One solution is to turn away, or refuse to serve, additional users that exceed the capacity of the network service. For example, a network service equipped to accommodate fifty users may refuse to serve any additional users (e.g., the fifty-first user). As such, the performance of the network service is maintained for the initial fifty users. However, the users that are turned away from the network service often never return, and instead find and return to other network services.

Another solution is to increase the capacity of the resources (e.g., by adding more servers, etc., than is estimated to be necessary for normal operating conditions). However, over-allocating resources can be costly and unnecessary. Many small or start-up companies may not be able to afford additional resources until, for example, sales volume increases. In addition, network services are subject to wide fluctuations in demand. User demand depends on a variety of factors, such as, the number of users, the time of day, etc. In addition, traffic to a particular network service can start out slow and due to advertising, linking, etc., grow exponentially in a short period of time. The timing of such increases in demand is often difficult to predict, making it difficult to anticipate or plan the resource capacity that is necessary to meet future demand.

### SUMMARY OF THE INVENTION

The inventors have devised an apparatus and method for providing user-requested content over a network (e.g., the Internet) through an alternate network service when a preferred network service is unavailable. For example, a user may access a preferred network service that is experiencing demand that exceeds the capacity of the resources allocated thereto, and is therefore unavailable. Instead of allowing the user to access the preferred network service, and thus degrade the performance of the preferred network service, or instead of refusing service to the user altogether, according to embodiments of the invention, the user is provided with the same content, or substantially similar content, through an alternate network service.

The apparatus is preferably embodied in computer readable program code stored on the computer readable storage media. For example, the computer readable program code may reside at least in part at the preferred network service. Or for example, the computer readable program code may reside at least in part at a user workstation, as a software application, as an Internet browser “plug-in” module, etc. Or in yet another example, the computer readable program code may be separately stored and accessed from the user workstation and/or from the preferred network service at least in part over the network (e.g., at a separate network service itself). The computer readable program code may comprise: program code for assessing the availability of the user-requested content from the preferred network service; program code for selecting an alternate network service providing the same content, or substantially similar content, as the user-requested content; and program code for linking to the alternate network service when the user-requested content is unavailable from the preferred network service.

Preferably, providing the user-requested content from the alternate network service is transparent to the user. That is, the user may be linked to the preferred network service (e.g., to the front-end service thereof), but the user-requested content may be provided via the alternate network service (e.g., via a back-end service at the alternate network service). According to this embodiment, a suitable protocol translation layer may be provided for communicating with the back-end service at the alternate network service and providing the user-requested content transparently to the user. As an example, an e-commerce site may be equipped to process payment information and provide the user with a confirmation of payment. However, when the e-commerce site is busy processing the payment information for other users, or is otherwise unavailable for processing the user's payment (e.g., the back-end service at the preferred network service is down), according to an embodiment of the invention, the user's payment information is transferred to an alternate network service (e.g., the back-end service thereof) for processing. As such, the user's payment information is processed, however, the user is unaware that the payment was processed at the alternate network service, as the user was not redirected or otherwise directly linked thereto. As another example, the user may link to a preferred search service, and where the preferred back-end service is unavailable to perform the search, the search is performed using the back-end service of another search service. The results are preferably presented to the user via the front-end service of the preferred network service (e.g., via the same interface and in the same format had the search been performed at the preferred network service).

In another embodiment, the user may be linked through an intermediary network service. That is, the user first links to the intermediary network service, and then links to other network services via the intermediary network service. The user-requested content may be provided from the alternate network service, transparently to the user, or the user may be linked to the alternate network service.

The apparatus also preferably comprises program code for monitoring the network and for identifying one or more alternate network services to provide content that is the same as, or substantially similar to, the user-requested requested content. Program code is also preferably provided for assessing the availability of the alternate network service. In addition, program code is preferably provided for profiling the availability of the user-requested content on the preferred network service and/or the alternate network service. The profile may comprise, for example, the frequency of transfers, the identity of the alternate network service(s), etc. The profile may be used for strategic alliances with other network services, for payment arrangements for the use of the alternate network service(s) that have handled the overflow, for allocating additional resources at the preferred network service, etc.

A method is also disclosed for providing the user-requested content over a network when the user-requested content is unavailable from a preferred network service. The method may comprise: assessing the availability of the preferred network service for providing the user-requested content; selecting an alternate network service also providing the user-requested requested content, or substantially similar content when the preferred network service is unavailable; and linking to the selected alternate network service to provide the user-requested content when the preferred network service is unavailable. Assessing the availability of the preferred network service may comprise comparing a load thereon to a threshold value, wherein the preferred network service is unavailable when the load exceeds the threshold. Preferably, the method also comprises assessing the availability of the alternate network service and linking thereto only when the alternate network service is available. The method may also comprise monitoring the network and identifying at least one alternate network service that provides the same, or substantially the same, content as the preferred network service. Preferably, the method also comprises profiling the preferred network service based on the availability thereof.

As such, embodiments of the invention provide the user-requested content, or content substantially similar thereto, when the demand approaches or exceeds the capacity of the resources allocated to the preferred network service. The user-requested content is provided without degrading the performance of the preferred network service for users already having access thereto. In addition, the user is not refused service, and the user-requested content, or substantially similar content, is still provided to the user. In addition, resources can be efficiently allocated to the network service, without over-allocating the resources.

These and other important advantages of the present invention will be further explained in, or will become apparent from, the accompanying description, drawings and claims.

### BRIEF DESCRIPTION OF THE DRAWINGS

Illustrative and presently preferred embodiments of the invention are illustrated in the drawings, in which:

FIG. 1 is a high-level diagram showing an overflow management tool for providing user-requested content through an alternate network service when a preferred network service is unavailable;

FIG. 2 illustrates an exemplary interface to the overflow management tool;

FIG. 3 illustrates another exemplary interface to the overflow management tool;

FIG. 4 illustrates yet another exemplary interface to the overflow management tool;

FIG. 5 illustrates an exemplary overflow database of the overflow management tool; and

FIG. 6 is a flow chart showing an embodiment of the method for providing user-requested content through an alternate network service.

### DESCRIPTION OF THE PREFERRED EMBODIMENT

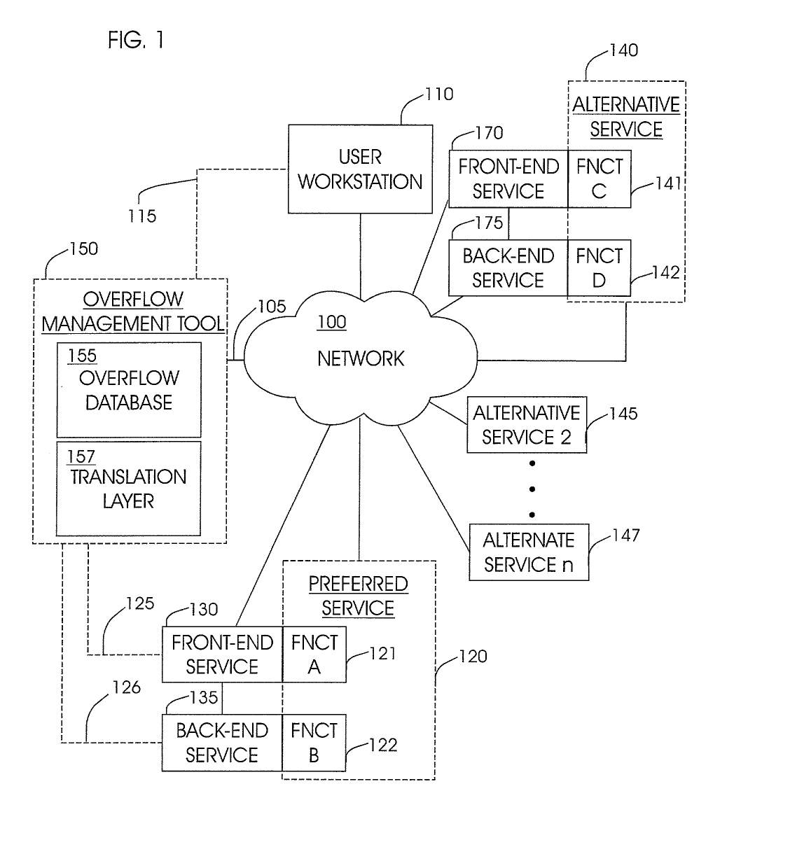

FIG. 1 is a high-level diagram showing a network 100 over which a user at a workstation 110 may link to a preferred network service 120. That is, the user at the workstation 110 (e.g., using an Internet browser) identifies the preferred network service 120 (e.g., using a uniform resource locator (URL), an IP address, etc.). A front-end service 130 may provide access to the preferred network service 120 (e.g., via an Internet home page), generally referred to as Function A (121). The user may also request additional content, generally referred to as Function B (122), such as search results, payment processing, etc., that is provided by a back-end service 135. Also shown in FIG. 1 is an overflow management tool 150 for providing the user-requested content through one or more alternate network services 140, 145, 147 when the preferred network service 120 is unavailable. For example, the user-requested content, or substantially similar content (e.g., Function C (141) and/or Function D (142)) may be provided to the user from one or more of the alternate network services 140, 145, 147.

The overflow management tool 150 preferably comprises an overflow database 155, and may also comprise a translation layer 157, where necessary. The overflow management tool 150 may be accessed via the network 100 (e.g., link 105); directly from the user workstation 110 (e.g., via link 115); directly from the preferred network service 120 (e.g., from the services 130, 135 via link 125 and/or link 126); or any suitable combination thereof, as explained in more detail below with respect to the preferred embodiments of the invention.

As an illustration, the requested content may be an Internet search engine. The user identifies the preferred network service 120 (e.g., http://www.PreferredSearchSvc.com) for the requested content (i.e., the search engine in this example) on the network 100 using an Internet browser (e.g., NETSCAPE NAVIGATOR®, MICROSOFT INTERNET EXPLORER®, etc.). However, any number of other users may also be accessing the same preferred network service 120 simultaneously. According to prior approaches, where the load (e.g., number of users, response time, etc.) exceeds the resources allocated to the preferred network service 120, the user is given access to the search engine, however, performance thereof declines as the number of users accessing the search engine increase above the capacity of the resources allocated thereto (e.g., back-end service 135). Alternately, and according to prior approaches, the user may be turned away or refused service (i.e., denied access to the search engine).

In the above illustration, and according to the teachings of the invention, the user identifies the preferred network service 120 for the requested content (e.g., Function A (121) and/or Function B (122)) on the network 100 using the Internet browser. Again, any number of other users may also be accessing the same preferred network service 120 simultaneously. Therefore, the availability of the preferred network service 120 is assessed. For example, the one or more of the services 130, 135 may be assessed for the availability thereof to provide the requested content or function 121, 122. The preferred network service 120 may be assessed based on the number of users, the response time, etc. Where the preferred network service 120 is unavailable, instead of providing the user with poor service or denying service to the user altogether, the user-requested content (or substantially similar content) is provided from one or more alternate network services 140, 145, 147 (e.g., Function C 141 or Function D 142). The user-requested content is preferably provided transparently to the user (e.g., from the back-end service 175 at the alternate network service 140) via the front-end service 130 of the preferred network service 120.

It is understood that the term “workstation” as used herein may be any suitable device, now known or later developed, such as but not limited to, a personal computer (PC), a laptop computer, a handheld computer, a wireless device (e.g., an analog or digital phone, Internet appliance), etc. Furthermore, the network 100 may be any suitable network, including the components thereof (e.g., routers, hubs, etc.). For example, the network 100 may be a local area network (LAN), a wide area network (WAN), an Intranet, the Internet, a wireless phone network, etc., or a combination thereof. Likewise, any suitable link may be established, either directly or indirectly, with the network 100. Suitable links may include, but are not limited to, a dial-up modem connection, a digital subscriber line (DSL), T-1 connection, cellular link, infrared link, BLUETOOTH(TM) link, satellite link, etc.

It is also understood that the preferred network service 120 and the alternate network services 140, 145, 147 are preferably Internet sites. However, the network services may be program code operating “behind the scenes” and are not necessarily directly accessed or linked thereto via a URL as an Internet site itself may be accessed. Indeed, it is understood that the user may be linked to one or more preferred network services 120 and/or one or more alternate network services 140, 145, 147 in any suitable manner, including, but not limited to, direct transfer, indirect transfer, via a permanent or semi-permanent connection, via dynamic transfer (e.g., based on the load thereon), etc. For example, a network service may be an encryption routine that operates in the background of a conventional Internet site. As such, the user may be linked to the Internet site, but not directly linked to the encryption routine. Other illustrations are given below.

It is further understood that the preferred network service 120 and the alternate network services 140, 145, 147 may be any suitable network services on the corresponding network 100. Likewise, it is understood that the front-end services 130, 170 and the back-end services 135, 175 are merely shown as examples. In other embodiments, the services need not be distinct services, may include additional services than those shown, etc.

A suitable translation layer 157 is preferably provided to translate protocols for access to the functions 141, 142 provided by the various alternate network services 140, 145, 147). The translation layer 157 may comprise suitable program code, translation databases, etc. As an example of its use, the translation layer 157 may facilitate communication between the front-end service 135 of the preferred network service 120 and the back-end service 175 of the alternate network service(s) 140, 145, 147, where necessary. The translation layer 157 may comprise readily available program code and databases, such as those provided by third-party vendors for access to their services (e.g., for payment processing, etc.), or may be specifically coded for use with preferred embodiments of the invention.

Preferably, the overflow management tool 150 is embodied in computer readable program code. However, the overflow management tool 150 may also be hardware, firmware, etc., or a combination thereof. In addition, the overflow management tool 150 may be a separate software and/or hardware module, integrated as part of another component (e.g., workstation 110, front-end service 130), etc. The overflow management tool 150 may be a “plug-in” module for an Internet browser, a separate application, or an Internet service through which the user operates. In addition, the overflow management tool 150 may reside at the workstation 110, at the preferred site 120 (e.g., at one of the services 130, 135), at a separate network service, etc. Likewise, the overflow management tool 150 may reside on or be accessed by a separate computer or processor at any one or more physical locations.

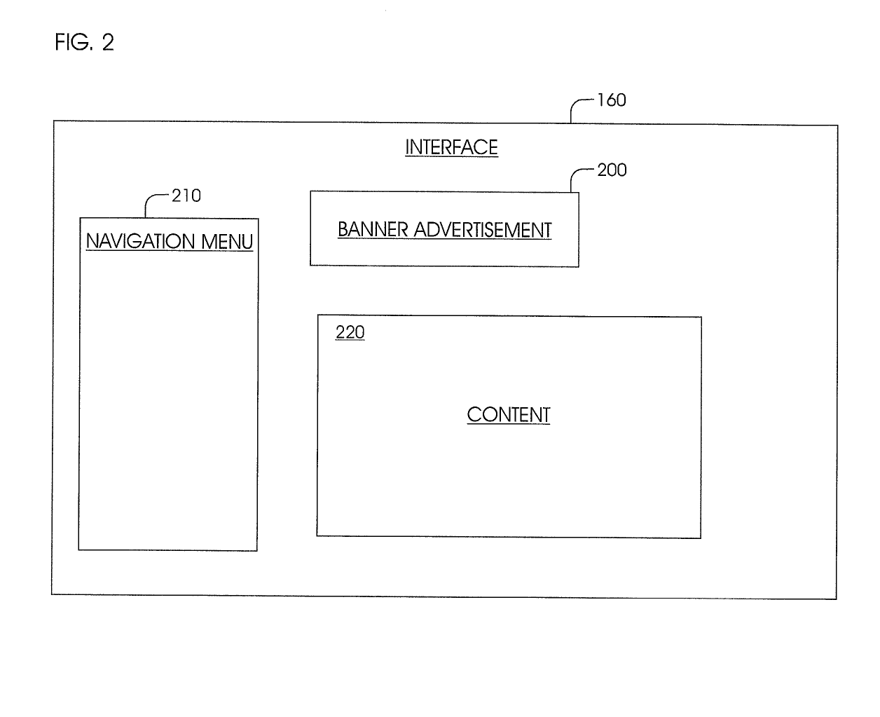

Preferably, the user-requested content, or substantially similar content, is provided from one or more of the alternate network services 140, 145, 147 transparently to the user. That is, the user may be linked to the preferred network service 120, but the user-requested content is provided via one of the alternate network services 140, 145, 147 (e.g., via a back-end service 175 at the alternate network service 140). This embodiment may be described as follows, with respect to the exemplary interface 160 shown in FIG. 2. Preferably, the interface 160 is a graphical user interface (GUI), such as may be displayed through an Internet browser. For example, when the user connects to the preferred network service 120, a banner advertisement 200, a navigation menu 210, and other content 220 may be displayed. According to preferred embodiments of the invention, when the preferred network service 120 is unavailable, the user-requested content is provided from one or more alternate network services 140, 145, 147. In this embodiment, although the user-requested content is provided from the alternate network services 140, 145, 147, it is displayed using the interface 160 as though the preferred network service 120 provided it. For example, the banner advertisement 200 and the navigation menu 210 from the preferred network service 120 may be displayed, while the content (e.g., search results) from the alternate network service 140, 145, 147 may be formatted and displayed as if the content were provided from the preferred network service 120.

As an illustration, the user may access an e-commerce Internet site (i.e., the preferred network service 120), select a good and/or service to purchase therefrom, and provide payment information (e.g., credit card information). The banner advertisement 200, navigation menu 210, and content 220 for the e-commerce site are displayed for the user at the workstation 110 via the front-end service 130 at the preferred network service 120. Also in this example, the back-end service 135 at the preferred network service 120 typically handles payment processing (e.g., 122). However, the preferred network service 120 may be unavailable for processing the payment of one or more additional users. For example, where there are other users providing payment information to the network service 120, the back-end service 135 may be unable to process the payments for each of the users. Or the back-end service 135 may be down or otherwise unavailable for processing the user's payment. According to preferred embodiments of the invention, the user's payment information is transferred to one of the alternate network services 140, 145, 147 (e.g., the back-end service 175 thereof) for processing (e.g., 142). As such, the user's payment is processed, the user receives confirmation of payment, and the user is unaware that the payment was processed at one of the alternate network services 140, 145, 147 (i.e., it is transparent to the user).

As another illustration, the user may access an Internet search engine (i.e., the preferred network service 120) and enter search terms. The banner advertisement 200, navigation menu 210, and content 220 for the search service are displayed for the user at the workstation 110 via the front-end service 130 at the preferred network service 120. Also in this example, the back-end service 135 at the preferred network service 120 typically handles search requests (e.g., 122). However, the preferred network service 120 may be unavailable for fulfilling the search requests for one or more additional users. For example, where there are other users requesting searches from the preferred network service 120, the back-end service 135 may be unable to fulfill the search requests for each of the users; or the back-end service 135 may be down or otherwise unavailable. Again, and according to preferred embodiments of the invention, the user's search terms are transferred to one of the alternate network services 140, 145, 147 (e.g., the back-end service 175 thereof) to fulfill the search request (e.g., 142). As such, the user receives the requested search results, and the user is unaware that the search was conducted through one of the alternate network services 140, 145, 147.

As yet another illustration, the user may access an Internet site (not shown) having a banner advertisement 200 for display thereon. The banner advertisement 200 may be stored at the preferred network service 120 of an advertising agency responsible for distributing the banner advertisement 200 to various Internet sites. When the Internet site is accessed by a user, the Internet site (e.g., a server at the Internet site) accesses the banner advertisement 200 from the advertising agency's preferred network service 120 (e.g., 121). However, where the advertising agency's preferred network service 120 is unavailable, according to preferred embodiments of the invention, the Internet site instead accesses the banner advertisement 200 from one of the advertising agency's alternate network services 140, 145, 147 (e.g., 141). As such, the user is provided with the requested content from the Internet site without having to wait while the Internet site attempts unsuccessfully to access the banner advertisement 200 from the advertising agency's preferred network service 120, before providing the user with the requested content.

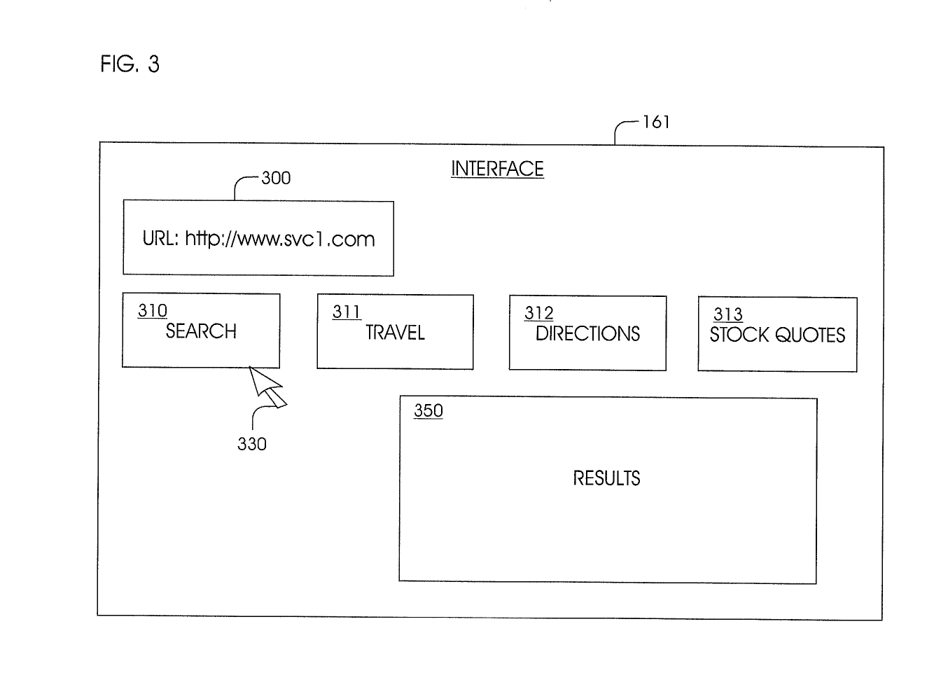

Yet another embodiment is illustrated using the exemplary interface 161 shown in FIG. 3. According to this embodiment, the user receives the requested content through an intermediary network service (e.g., link 105 to the overflow management tool 150) or via an application at the user workstation 110. That is, the user accesses the intermediary network service, and then accesses other network services through the intermediary network service.

As an illustration, the interface 161 may include an address box 300 for specifying the preferred network service 120 (e.g., by URL, IP address, etc.). The user may enter the URL for a preferred search engine (e.g., http://www.PreferredSearchEngine.com) in the address box 300, and the overflow management tool 150 assesses the availability of the preferred network service 120. Where the preferred network service 120 is available, the requested content (i.e., the results 350 from the requested search engine) is provided for the user. However, where the preferred network service 120 is unavailable, the overflow management tool 150 instead provides the user-requested content (i.e., search results 350) from one of the alternate network services 140, 145, 147 (i.e., an alternate search engine such as 142).

As another illustration, the interface 161 may include categories 310, 311, 312, 313 from which the user may request content. The user selects the preferred network service 120 using one of the categories 310-313, for example, by pointing the cursor 330 to the corresponding icon (e.g., 310). In any event, the overflow management tool 150 assesses the availability of the preferred network service 120. Where the preferred network service 120 is available, the requested content is provided for the user. However, where the preferred network service 120 is unavailable, the overflow management tool 150 instead provides the user-requested content from one of the alternate network services 140, 145, 147.

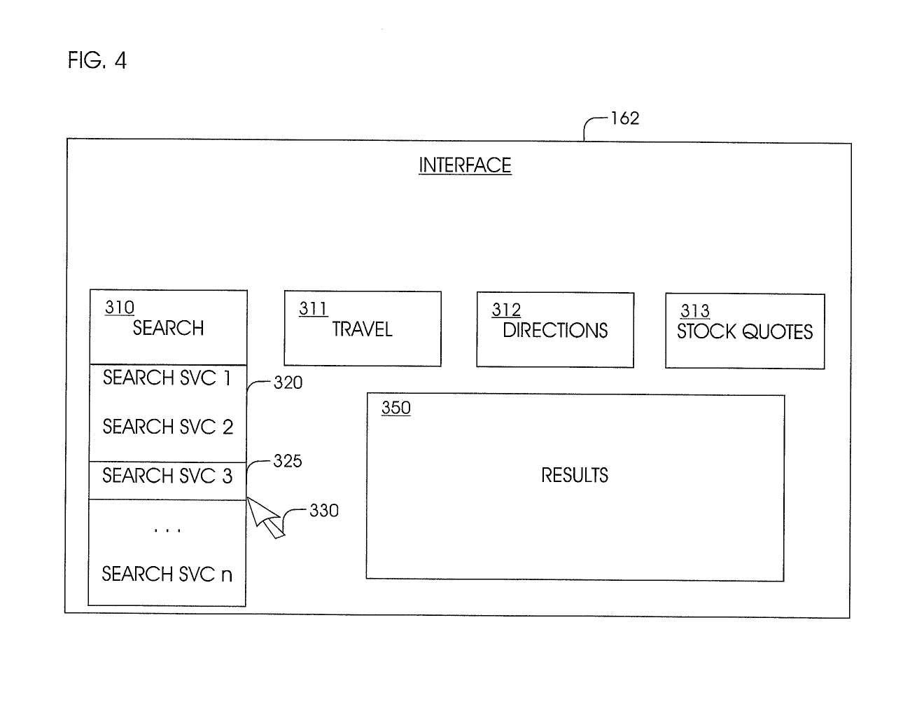

Yet another embodiment is illustrated using the exemplary interface 162 shown in FIG. 4. According to this embodiment, the user again receives the requested content through an intermediary network service (e.g., link 105 to the overflow management tool 150) or an application at the user workstation 110. However, in this embodiment, the user refines the request for content by selecting the content using subcategories, network names, or the like, from the menu 320 (e.g., selection 325).

It is to be understood that the interfaces 160-162 shown in FIG. 2, FIG. 3, and FIG. 4 are merely illustrative of interfaces, and are not intended to limit the scope of the invention thereto. For example, any suitable content may be displayed therein. It is also understood that the interfaces 160, 161 and 162 may include any suitable icons, menus, and any other interactive display. For example, the categories 310-313 may include, for example, “search”, “travel”, “directions”, “stock quotes”, or any other predefined and/or user-defined category. Likewise, subcategories may also be provided (e.g., “Travel—Vacation”, “Travel—Business”, “Directions—Texas”, “Directions—Colorado—Denver”, etc.). Or for example, the user may select a network name (e.g., “Search Svc 3” (325), “http://www.SearchSvc.com”, etc.) from the menu 320. Furthermore, the preferred network service 120 for the category 310-313, subcategory, or network name, etc., may be predefined by the user, by an administrator, based on a subscription or strategic alliance, dynamically based on monitoring the various network services, etc.

According to the embodiments described with respect to FIG. 2, FIG. 3, and FIG. 4, the user-requested content is preferably provided transparently to the user. Alternately, the user-requested content may be provided through the interface 160-162, for example, by “framing” the user-requested content as content 220 or results 350. As such, the user may select another preferred network service 120, for example, using the address box 300, or the categories 310-313, without having to “backtrack”.

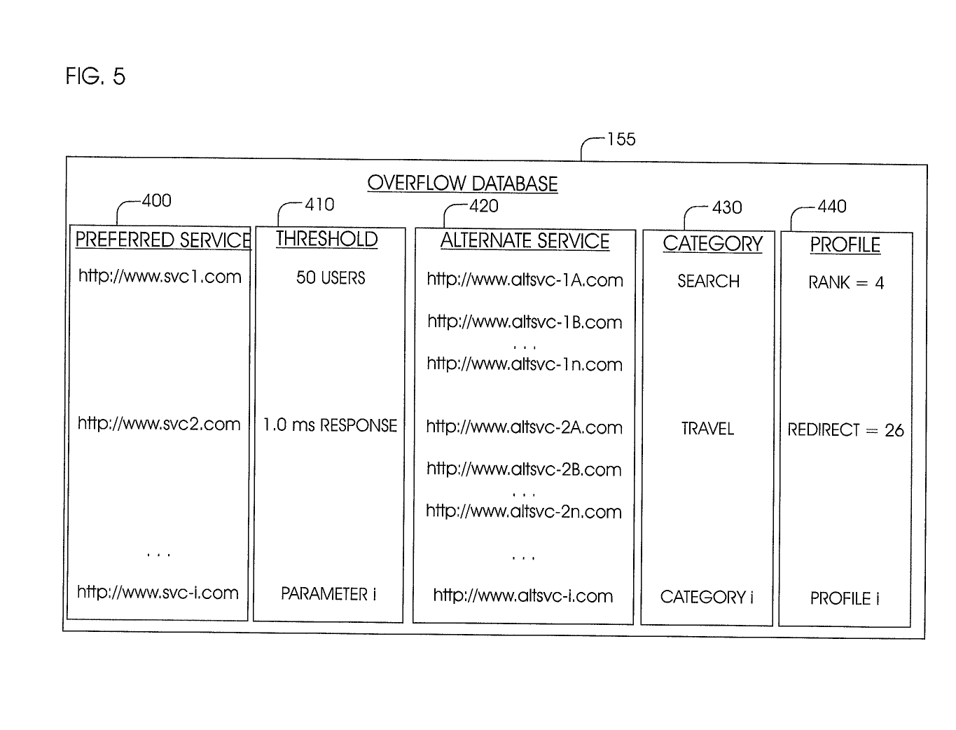

FIG. 5 illustrates an exemplary overflow database 155. The overflow database 155 may include various fields, such as, a preferred service(s) field 400, a threshold field 410, and an alternate service(s) field 420. The preferred service field 400 identifies the preferred network service(s) 120. The threshold field 410 identifies one or more thresholds for the preferred network service 120 identified by the preferred service field 400. For example, the preferred network service 120 “http://www.svc1.com” has a threshold value of “fifty users”. Thus, when the preferred network service 120 is serving fifty users and another user requests access thereto, the preferred network service 120 is considered unavailable according to preferred embodiments of the invention. As such, an alternate network service 140, 145, 147 that provides the same or substantially the same content as that requested by the user from the preferred network service 120 is identified and selected from the alternate service field 420.

It is understood that the overflow database 155 shown in FIG. 4 is given merely as an example and is not intended to limit the scope of the invention thereto. Preferably, the overflow database 155 is a relational database, however, it may take any suitable form and stored on any suitable storage media for use by the overflow management tool 150. The preferred network service(s) 120 may be identified in field 400 in any suitable manner, and need not be an Internet URL as shown in FIG. 4. In addition, any suitable threshold may be defined in the threshold field 410. For example, the threshold may be based on the number of users, average response time, etc. In addition, the threshold may be defined at the preferred network service 120 (e.g., by an administrator), may be set by the user, may be based on independent monitoring of the preferred network service 120, etc. Likewise, the alternate network service(s) 140, 145, 147 defined in the alternate service field 420 may be user-defined, determined automatically (e.g., using Internet “bots”), ranked, included based on strategic alliances or ownership of the various services, etc. In addition, the alternate network service(s) 140, 145, 147 may be identified in field 420 in any suitable manner.

In addition, the overflow database 155 may include additional fields. For example, the overflow database 155 may also include a content or category field 430. The category field may be used to identify preferred network services 120 and the associated alternate network services 140, 145, 147 based on the category selections made by the user (e.g., categories 310-313). Or for example, the overflow database 155 may also include a profile field 440 for information, statistical or otherwise, related to the availability of the preferred network service 120 and/or the alternate network services 140, 145, 147 (e.g., the frequency of transfers, patterns of unavailability, etc.). Other information may also be gathered for profiling the preferred network service 120, such as user information gathered from Internet “cookies”.

Information collected in the profile field 440 may be used to generate a service profile (not shown). For example, the service profile may be used to identify periods of peak demand so that additional capacity can be added during those periods. Or for example, the service profile may be used to determine which alternate network services 140, 145, 147 satisfy the user's requests for use in strategic alliances. Or for example, the service profile may be used to determine the frequency with which an alternate network service 140, 145, 147 was accessed so that suitable payment arrangements may be made. Or for example, the service profile may be used to identify bottlenecks on the network 100 itself that affect the availability of the preferred network service 120. That is, the bottleneck may be elsewhere on the network 100 (e.g., a router, hub, etc.), and not necessarily at the preferred network service 120. This may be determined, for example, where the user is transferred to an alternate network service 140, 145, 147 at a time when the preferred network service 120 is locally available (e.g., the back-end service 135 is not busy). Therefore, increasing resource capacity at the preferred network service 120 may not increase the availability thereof. Instead, additional services may need to be deployed at other physical locations on the network 120, or the bottlenecks on the network 100 itself may need to be addressed, to better provide the user-requested content from the preferred network service 120.

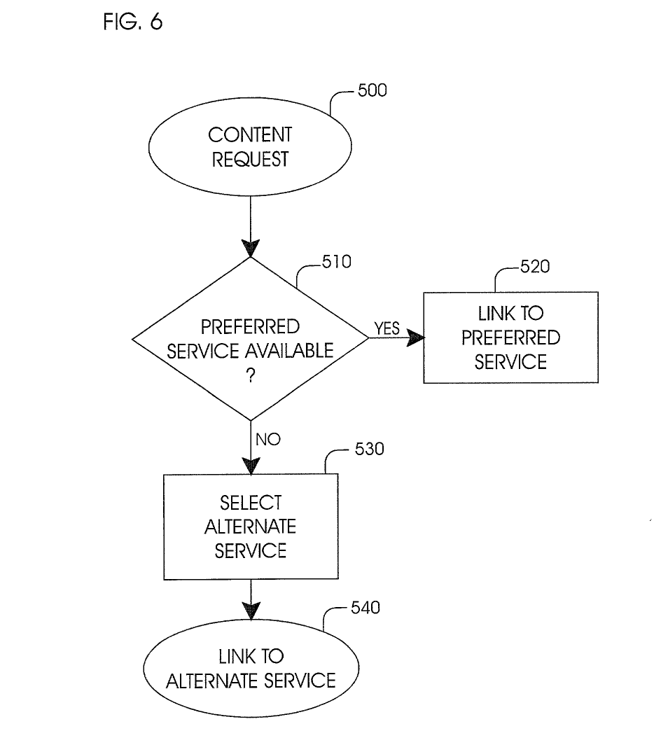

An embodiment of the method for providing user-requested content through at least one of the alternate network services 140, 145, 147 according to the teachings of the invention is shown in FIG. 6. The method may comprise receiving a request for content in step 500. For example, the user may request content through the interface 160 by specifying a URL for a preferred network service 120, by selecting a category (e.g., 310), etc. In step 510, the availability of the preferred network service 120 is assessed. The availability may be that of the entire network service. Alternately, the availability may be that of a portion thereof, such as the availability of the back-end service 135, a function of the network service (e.g., payment processing), etc. Assessing the availability of the preferred network service 120 (and the alternate network services 140, 145, 147, where applicable) preferably comprises comparing a load thereon to a threshold value (e.g., according to the threshold field 410). The load is preferably determined using a synthetic transaction. A synthetic transaction is a short data packet transmitted to the network service to generate a response, from which the response time is measured. However, other methods for determining the load on the network service may also be used according to the teachings of the invention, such as, but not limited to, a network bandwidth service, pinging the network service, etc. Where the load at the network service exceeds the threshold, the network service is considered unavailable.

Where the user-requested content is available from the preferred network service 120, the user is linked thereto in step 520. However, where the user-requested content is not available from the preferred network service 120, an alternate network service 140, 145, 147 also providing the user-requested content (or substantially similar content) is selected in step 530. The alternate network service 140, 145, 147 is selected based preferably at least in part on the availability thereof. However, the selection may be based on other factors as well, such as, but not limited to, a ranking of the alternate network services, strategic alliances, user preferences, etc. In step 540, the user is linked to the alternate network service 140, 145, 147 selected in step 530, wherein the user-requested content is provided to the user even when the preferred network service 120 is unavailable.

It is understood that the method shown in FIG. 6 is merely illustrative of one embodiment of the method of the invention, and that other embodiments are also contemplated as being within the scope of the invention. For example, in another embodiment, the method may also include the steps of profiling the preferred network service 120 based on the availability thereof, and allocating additional resources (e.g., servers, processors, etc.) based on the generated profile.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing user-requested content over a network, comprising:
assessing the availability of a preferred network service providing said user-requested content;
selecting an alternate network service providing substantially the same content as said user-requested content when said preferred network service is unavailable; and
linking to said selected alternate network service to provide substantially the same content as said user-requested content when said preferred network service is unavailable.

2. A method as in claim 1, wherein assessing the availability of said preferred network service comprises comparing a load thereon to a threshold, and wherein said preferred network service is unavailable when said load exceeds said threshold.

3. A method as in claim 1, further comprising assessing the availability of said alternate network service and linking thereto only when said alternate network service is available.

4. A method as in claim 1, further comprising:
monitoring said network; and
identifying said alternate network service on said network.

5. A method as in claim 1, further comprising profiling said preferred network service based on the availability thereof.

6. A method as in claim 5, further comprising allocating additional resources to said preferred network service based on said profiling thereof.

7. A method as in claim 1, wherein linking to said alternate network service is transparent to a user.

8. A method as in claim 1, wherein linking to said alternate network service comprises performing a function at said alternate network service.

9. An apparatus for providing user-requested content over a network when the user-requested content is unavailable from a preferred network service, comprising:
computer readable storage media;
computer readable program code stored on said computer readable storage media, comprising:
a) program code for assessing the availability of said user-requested content from said preferred network service;
b) program code for selecting an alternate network service providing substantially similar content to said user-requested content if said user-requested content is unavailable from said preferred network service; and
c) program code for linking to said alternate network service when said user-requested content is unavailable from said preferred network service.

10. An apparatus as in claim 9, wherein said program code for assessing the availability determines that said user-requested content is unavailable when a load on said preferred network service exceeds a threshold.

11. An apparatus as in claim 9, further comprising a translation layer comprising:
a translation database; and
program code for translating between protocols for said preferred network service and said alternate network service based on said translation database.

12. An apparatus as in claim 9, further comprising program code for assessing the availability of said substantially similar content from said alternate network service and providing said substantially similar content to a user when said substantially similar content is available therefrom.

13. An apparatus as in claim 9, further comprising a database of alternate network services, wherein said selected alternate network service is in said database of alternate network services.

14. An apparatus as in claim 9, further comprising program code for profiling the availability of said user-requested content from said preferred network service.

15. An apparatus as in claim 9, further comprising:
program code for monitoring said network; and
program code for identifying said alternate network service on said network.

16. An apparatus as in claim 9, wherein said computer readable program code resides at least in part at said preferred network service.

17. An apparatus as in claim 9, wherein said computer readable program code resides at least in part at a user workstation.

18. An apparatus as in claim 9, wherein said computer readable program code is accessed at least in part over said network.

19. An apparatus for providing user-requested content from an alternate network service when the user-requested content is unavailable from a preferred network service, comprising:
means for assessing the ability of said preferred network service to provide said user-requested content;
means for selecting said alternate network service providing said user-requested content when said preferred network service is unable to provide said user-requested content; and
linking to said alternate network service when said preferred network service is unable to provide at least a portion of said user-requested content.

20. An apparatus as in claim 19, further comprising means for profiling said preferred network service.
